(19) United States
(12) Patent Application Publication
(10) Pub. No.: US 2006/0040827 A1
(43) Pub. Date: Feb. 23, 2006

(54) Environmentally safe herbicide, fungicide, bactericide and adjuvant composition

(76) Inventor: A. Harry J. Rajamannan, Minneapolis, MN (US)

Correspondence Address: Herman H. Bains, 6101 Tracy Ave, Edina, MN, 55436, US

(21) Appl. No.: 10/921,251

(22) Filed: Aug. 19, 2004

(51) Int. Cl. A01N 25/00

(52) U.S. Cl. 504/358; 424/405

(57) ABSTRACT

An environmentally safe herbicide, fungicide and adjuvant including a wax which adheres the composition to a plant surface. The composition includes oils, surfactants, fatty acids of oils, emulsifier, and mineral oil.

### FIELD OF THE INVENTION

This invention relates to a novel, environmentally safe herbicide, fungicide, bactericide and adjuvant composition which uses wax as an adherent and penetrant which is effective in destroying weeds, fungi and bacteria.

### BACKGROUND OF THE INVENTION

Currently used herbicides and fungicides are hazardous to the environment and to the farmers using them. These herbicides and fungicides are not only inherently dangerous to environment and people, but are inefficient since they readily wash off the plants to which they are applied.

### SUMMARY OF THE INVENTION

An object of this invention is the provision of a novel pesticide or herbicide composition including a rain resistant and wax containing a surfactant, natural oils having insect repelling properties and fatty acids having cuticle tearing properties. In addition to or in lieu of the natural oils or fatty acids, salts of sodium, potassium or ammonia of these oils can also be added.

### DESCRIPTION OF THE PREFERRED EMBODIMENT

Many commercially available herbicides, and fungicides are not only environmentally hazardous but when applied to plant surfaces will wash off in rains.

In the present invention, a wax incorporates the fungicidal and herbicidal ingredients and serves as an effective penetrant and adhesive when applied to plant surfaces. The composition will form a waxy coat on the plant surfaces and will not wash off in rains.

The wax may be a petroleum wax or natural wax. In addition to petroleum or natural waxes, water or alcohol soluble synthetic waxes such as acrylic polymers acrylic copolymers or styrene acrylic copolymers may be used. Since some waxes are not readily soluble, it may be necessary to use a solvent in cases of water insoluble waxes.

The composition also includes a surfactant, alcohol, detergent or emulsifier. The surfactants can be any of the well-known anionic, cationic or non-ionic surfactants. The standard emulsifier used around the world and sold under the trade designation NP7 can be used.

The composition may include oils from coconuts, citrus, soybeans and peanuts, and potassium, sodium and ammonia salts of the fatty acids from these oils. The oils from citronella and neem may also be used. These natural oils have properties for repelling insects. The fatty acids in these oils have plant cuticle tearing properties.

Mineral oils are an inexpensive source as an emulsifier in water and the oil prevents evaporation of the spray droplets when the composition is applied as a spray from the ground or from planes or helicopters. Mineral oil can therefore be added to the composition for this effect. Emulsifier such as ethoxylated alcohols, quartenary surfactants, sulfonates and alkanolamides may also be used.

The composition or formulation when used at low amounts or concentrations of about 2% or lower acts as an excellent adjuvant for conventional use of pesticides, fertilizers and plant growth regulators. The composition sticks or adheres the active ingredients to plant and the wax which coats the plant surface will not wash off during rain.

In concentration of 2% to 5% when used alone or with a conventional pesticide, the composition functions as a fungicide or bactericide. Concentration of the compositions of 5% to 50% of the final spray mixture serves as an efficient herbicide.

As certain of the following examples show, the novel composition was compared to the herbicide, glyphosate. Glyphosate, N-(phosphonomethyl) glycine is a well-known herbicide sold under trademarks Roundup, Rodeo and Accord.

The novel composition was also compared to the well-known fungicide, dithane. In certain of the examples, applicant used Orchex 796, Spraytex oil produced by Texaco Corporation may also be used.

### EXAMPLES

Cocktail I

Polymer such as acrylic polymers, acrylic copolymers or styrene based acrylic copolymers are water based are easy to use in a cocktail with 5% of one of these polymers is added to an emulsifier such as ethoxylated alcohols, quartenary surfactants, sulfonates and alkanolamides is used at 5%

To this, is added citrus oil at 5%. The final addition is mineral oil “Orchex” at 85%.

This cocktail can be mixed with water prior to use at 1:5 parts of water to 1:200 parts of water. The higher the concentration of the cocktail the faster the kill of the weeds. Cocktail I was compared against glyphosate (5%).

### EXAMPLES

GRASS AND BROAD LEAF KILL

| | 24 HOURS | 7 DAYS |
|---|---|---|
| Glyphosate 5% | 10% | 100% |
| Cocktail I | 27% | 100% |

Cocktail II

Same as Cocktail I to this mixture add instead of natural oil, fatty acids Oleic, Lauric, Pelargonic at 5%.

Compared against Glyphosate at 5%:

| | BROAD LEAF AND GRASS KILL | | |
|---|---|---|---|
| | 24 HOURS | 2 DAYS | 7 DAYS |
| Glyphosate 5% | 10% | 20% | 100% |
| Cocktail II | 30% | 70% | 100% |

Cocktail II

Same as Cocktail I but add concentrated glyphosate to yield 1% glyphosate in mix.

| | BROAD LEAF AND GRASS KILL | | |
|---|---|---|---|
| | 24 HOURS | 2 DAYS | 7 DAYS |
| Glyphosate 5% | 10% | 20% | 100% |
| Cocktail III | 40% | 80% | 100% |

Cocktail IV

Acrylic copolymer 5% emulsifier 5% oleic fatty acid 2% mineral oil 88%. This mix is mixed with water at 1:5 bases.

Single banana leaves were sprayed in Costa Rica where black sigatoka is endemic with Cocktail IV and Dithane (DuPont) was sprayed as control.

| | Infection Post Spray | | |
|---|---|---|---|
| | 2 Weeks | 4 Weeks | 6 Weeks |
| Dithane | Zero | 2% | 70% |
| Cocktail IV | Zero | Zero | 5% |

This experiment showed that Cocktail IV was as good as Dithane.

Cocktail V

Here the wax such as acrylic copolymer 2% was mixed ethoxylated alcohol at 5% and this was mixed with Orchex (mineral oil from Exxon) and used as an adjuvant with Dithane. Cocktail V was used at 1% of the final cocktail.

Control was Dithane and Orchex with an emulsifier, NP7* at 1% of the cocktail was sprayed on single leaves of banana in Costa Rica.

*NP7 is the standard emulsifier used around the world in their banana spray for sigatoka control.

| | Infection Post Spray | | |
|---|---|---|---|
| | 2 weeks | 4 Weeks | 6 Weeks |
| Dithane + NP7 + | Zero | 2% | 10% |
| Orchex | | | |
| Dithane + Cocktail V + | Zero | Zero | 2% |
| Orchex | | | |

Here Cocktail V was superior to NP7 and the Dithane was not washed off by the rains prevalent in Costa Rica.

What is claimed is:

1. An environmentally safe herbicide fungicide, bactericide, insecticide and adjuvant composition comprising
a rain resistant and sealant wax selected from the group consisting of petroleum wax, natural wax or synthetic wax,
an oil or the fatty acids from the oil,
a surfactant or emulsifier,
and a mineral oil.

2. The composition as defined in claim 1 wherein the wax is a natural wax soluble in water or alcohol and when applied to a plant surface will form a waxy coat which is rain resistant.

3. The composition as defined in claim 1 wherein the wax is a synthetic wax selected from the group consisting of acrylic polymers, acrylic copolymers and styrene acrylic copolymers, said synthetic wax being water or alcohol soluble and when applied to a plant surface forming a waxy coat which is rain resistant.

4. The composition as defined in claim 1 wherein the oil is selected from the group consisting of coconut oil, citrus oil, soybean oil, peanut oil, oleic oil, lauric oil and pelargonic oil.

5. The composition as defined in claim 4 and the salts of potassium derived from one of said oils.

6. The composition as defined in claim 4 and the salts of sodium derived from one of said oils.

7. The composition as defined in claim 4 and salts of ammonia derived from one of said oils.

8. The composition as defined in claim 1 wherein said surfactant is selected from the group consisting of anionic, cationic or non-ionic surfactants.

9. The composition as defined in claim 1 the mineral oil comprises a commercially available mineral oil.

10. The composition as defined in claim 1 wherein 5% by weight of a commercial herbicide selected from the group consisting of glyphosate, 2-4D and Gramaxxone is added to composition.

11. The composition as defined in claim 1 wherein 5% by weight of a fungicide including dithane is added to the composition.

12. The composition as defined in claim 1 wherein the concentration of the composition not greater than 5% functions as a pesticide, fertilizer and plant growth regulator and is resistant to rain.
